(19) United States
(12) Patent Application Publication
(10) Pub. No.: US 2012/0273055 A1
(43) Pub. Date: Nov. 1, 2012

(54) ANNULAR RELIEF VALVE

(76) Inventors: Brent J. Lirette, Cypress, TX (US); Michael LoGiudice, Cypress, TX (US); George W. Ribble, Houma, LA (US); Stephanie Dianne Wind, Houston, TX (US); Frederick T. Tilton, Spring, TX (US)

(21) Appl. No.: 13/458,473

(22) Filed: Apr. 27, 2012

Related U.S. Application Data
(60) Provisional application No. 61/605,568, filed on Mar. 1, 2012.
(60) Provisional application No. 61/583,085, filed on Jan. 4, 2012.
(60) Provisional application No. 61/535,840, filed on Sep. 16, 2011.
(60) Provisional application No. 61/481,135, filed on Apr. 29, 2011.

(51) Int. Cl. F16K 17/04; F16K 15/08; F16K 17/06

(52) U.S. Cl. 137/14; 137/515; 137/540

(57) ABSTRACT

A pressure relief valve assembly may be coupled to one or more casings and/or tubular members to control fluid communication therebetween. The valve assembly is a one-way valve assembly that relieves pressure within an annulus formed between adjacent casings and/or tubular members to prevent burst or collapse of the casings and/or tubular members. In one embodiment, the valve assembly includes a tubular body having a port for fluid communication between an exterior of the valve assembly and an interior of the valve assembly; a chamber formed in a wall of the tubular body, the chamber in fluid communication with the port; and a closure member disposed in the chamber and configured to control fluid communication through the port in response to a pressure differential.

### CROSS-REFERENCE TO RELATED APPLICATIONS

This application claims benefit of U.S. Provisional Patent Application Ser. No. 61/605,568, filed Mar. 1, 2012; and benefit of U.S. Provisional Patent Application Ser. No. 61/583,085, filed Jan. 4, 2012; and benefit of U.S. Provisional Patent Application Ser. No. 61/535,840, filed Sep. 16, 2011; and benefit of U.S. Provisional Patent Application Ser. No. 61/481,135, filed Apr. 29, 2011, which applications are incorporated herein by reference in their entirety.

### BACKGROUND OF THE INVENTION

1. Field of the Invention

Embodiments of the invention generally relate to a pressure relief valve assembly for a casing.

2. Description of the Related Art

Traditional well construction, such as the drilling of an oil or gas well, includes a wellbore or borehole being drilled through a series of formations. Each formation, through which the well passes, must be sealed so as to avoid an undesirable passage of formation fluids, gases or materials out of the formation and into the borehole. Conventional well architecture includes cementing casings in the borehole to isolate or seal each formation. The casings prevent the collapse of the borehole wall and prevent the undesired inflow of fluids from the formation into the borehole.

In standard practice, each succeeding casing placed in the wellbore has an outside diameter significantly reduced in size when compared to the casing previously installed. The borehole is drilled in intervals whereby a casing, which is to be installed in a lower borehole interval, is lowered through a previously installed casing of an upper borehole interval and then cemented in the borehole. The purpose of the cement around the casing is to fix the casing in the well and to seal the borehole around the casing in order to prevent vertical flow of fluid alongside the casing towards other formation layers or even to the earth's surface.

If the cement seal is breached, due to high pressure in the formations and/or poor bonding in the cement for example, fluids (liquid or gas) may begin to migrate up the borehole. The fluids may flow into the annuli between previously installed casings and cause undesirable pressure differentials across the casings. The fluid gas may also flow into the annuli between the casings and other drilling or production tubular members that are disposed in the borehole. Some of the casings and other tubulars, such as the larger diameter casings, may not be rated to handle the unexpected pressure increases, which can result in the collapse or burst of a casing or tubular.

Therefore, there is a need for apparatus and methods to prevent wellbore casing or tubular failure due to unexpected downhole pressure changes.

### SUMMARY OF THE INVENTION

In one embodiment, a valve assembly includes a tubular body having a port for fluid communication; a collar disposed around the tubular body; and a closure member disposed inside the collar and configured to control fluid communication through the port in response to a pressure differential. In another embodiment, the collar is eccentrically disposed relative to the body. In yet another embodiment, the closure member may be a sleeve or a piston.

In another embodiment, a valve assembly includes a tubular body having a port for fluid communication between an exterior of the valve assembly and an interior of the valve assembly; a chamber formed in a wall of the tubular body, the chamber in fluid communication with the port; and a closure member disposed in the chamber and configured to control fluid communication through the port in response to a pressure differential. In yet another embodiment, the valve assembly includes a biasing member for biasing the closure member in a closed position. The valve assembly may include a plug disposed on an end opposite the closure member. In one aspect, the activation force of the closure member is adjustable. The activation force may be adjusted by changing a location of the plug.

In another embodiment, the chamber is formed at an angle relative to a longitudinal axis of the tubular body. The angle may be an acute angle, or the angle may be about 5 degrees to 75 degrees. In yet another embodiment, the chamber is substantially formed in a raised portion of the wall having an increased wall thickness. In yet another embodiment, a fluid path formed on the raised portion in communication with the exterior port.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic view of a wellbore.

FIG. 2 is a partial cross sectional view of one embodiment of a valve assembly in a closed position.

FIG. 3 is a cross sectional view of the valve assembly of FIG. 2 in an open position.

FIG. 4 is a partial cross sectional view of another embodiment of a valve assembly in a closed position.

FIG. 5 is a cross sectional view of the valve assembly of FIG. 4 in an open position.

FIG. 6 is partial cross-sectional view of another embodiment of a pressure valve assembly.

FIG. 7 is partial cross-sectional view of another embodiment of a pressure valve assembly.

FIG. 8 is partial cross-sectional view of another embodiment of a pressure valve assembly.

FIG. 9 is a partial cross sectional view of another embodiment of a valve assembly in a closed position.

FIG. 10 is a cross sectional view of the valve assembly of FIG. 9 in an open position.

FIG. 11 is a cross-sectional view of another embodiment of a valve assembly. FIG. 11A is a longitudinal cross-sectional view of the valve assembly of FIG. 11.

FIG. 12 shows the valve assembly of FIG. 11 in a closed position.

FIG. 13 shows the valve assembly of FIG. 11 in an open position.

FIG. 14 is a partial cross-sectional view of another exemplary embodiment of a valve assembly in a closed position.

FIG. 15 is a partial cross-sectional view of the valve assembly of FIG. 14 in an open position.

FIG. 16 illustrates an exemplary closure member suitable for use with the valve assembly of FIG. 14.

FIG. 17 is an enlarged partial view of the plug of the valve assembly of FIG. 14.

FIG. 18 illustrates an exemplary plug suitable for use with the valve assembly of FIG. 14.

FIG. 18A illustrates another exemplary plug suitable for use with the valve assembly of FIG. 14.

FIGS. 19-23 illustrate another embodiment of a tubular body for a valve assembly. FIG. 19 is a perspective view of one end of the tubular body 905.

FIG. 20 is a cross-sectional view of the tubular body of FIG. 19 taken at line A-A.

FIG. 21 is a cross-sectional view of the tubular body of FIG. 19 taken at line B-B.

FIG. 22 is a cross-sectional view of the tubular body of FIG. 19 taken at line D-D.

FIG. 23 is a cross-sectional view of the tubular body of FIG. 19 taken at line C-C.

### DETAILED DESCRIPTION

In one embodiment, a pressure relief valve assembly may be coupled to one or more casings and/or tubular members to control fluid communication therebetween. The valve assembly is a one-way valve assembly that relieves pressure within an annulus formed between adjacent casings and/or tubular members to prevent burst or collapse of the casings and/or tubular members. The valve assembly may be resettable downhole.

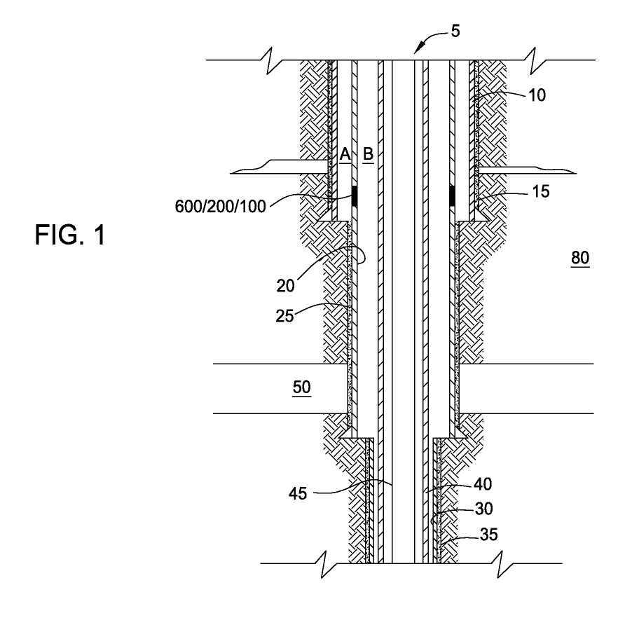

FIG. 1 illustrates a wellbore 5 formed within an earthen formation 80. The walls of the wellbore 5 are reinforced with a plurality of casings 10, 20, 30 of varying diameters that are structurally supported within the formation 80. The casings 10, 20, 30 are fixed within the formation 80 using a sealing material 15, 25, 35, such as cement, which prevents the migration of fluids from the formation 80 into the annuli between the casings 10, 20, 30. One or more tubular members 40, 45, such as drilling or production tubular members, may also be disposed in the wellbore 5 for conducting wellbore operations. An annulus “A” is formed between the casing 10 and the casing 20, and an annulus “B” is formed between the casing 20 and the tubular member 40, which may also be a casing. It is important to note that the embodiments described herein may be used with other wellbore arrangements and are not limited to use with the wellbore configuration illustrated in FIG. 1.

The wellbore 5 may intersect a high pressure zone 50 within the formation 80. Fluids within the high pressure zone 50 are sealed from the annulus A and B by the sealing material 25 that is disposed between the casing 20 and the wellbore wall. In the event that the sealing material 25 is breached or otherwise compromised, pressurized fluids may migrate upward into the annulus A and cause an unexpected pressure increase. The pressure rise may form a pressure differential across the casings 10, 20 that, if unchecked, may result in leakage through or burst of casing 10, and/or leakage through or collapse of casing 20. One or more valve assemblies 100, 200, 600 are provided to relieve the pressure in the annulus A prior to failure of one or both of the casings 10, 20.

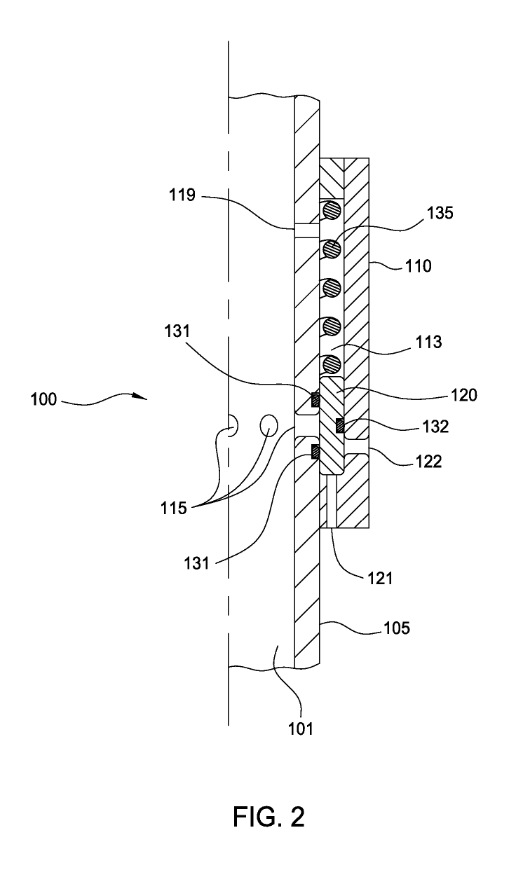

FIG. 2 illustrates an exemplary embodiment of a valve assembly 100 for relieving pressure in annulus A to prevent failure of the casings 10, 20. The valve assembly 100 may be coupled to the casing 20 in FIG. 1, but each of the casings 10, 20, 30 and/or the tubular members 40, 45 may similarly include one or more of the valve assembly 100 as described herein. The valve assembly 100 may be coupled to the casings 10, 20, 30 and/or the tubular members 40, 45 using a thread connection, a welded connection, and/or other similar connection arrangements. The valve assembly 100 may also be integral with the casings.

FIG. 2 is partial cross-sectional view of the valve assembly 100 in a closed position. The valve assembly 100 includes a tubular body 105 connectable to casing 20 to form a part of the casing string. The body 105 has an axial bore 101 having an inner diameter equal to or greater than the inner diameter of the casing 20. One or more relief ports 115 are formed through the wall of the body 105 for fluid communication between an exterior of the casing 20 and an interior of the casing 20. As shown in FIG. 2, the body 105 includes a plurality of relief ports 115 circumferentially spaced around the body 105. It must be noted the body 105 may include any suitable number of relief ports, for example, one, two, four, or more ports. Additionally, the body 105 may include multiple ports disposed at different locations along the length of the body 105. Ports disposed at different axial locations on the body 105 may reduce the effect the ports have on the integrity, e.g., tensile strength, of the valve body 105.

A tubular collar 110 is disposed around the outside of the body 105, as shown in FIG. 2. The collar 110 may be attached to the body 105 using a fastener, screw, weld, or other suitable attachment mechanisms. The collar 110 is configured and arranged such that an annular chamber 113 is formed between the collar 110 and the body 105. The annular chamber 113 can fluidly communicate with the relief ports 115 of the body 105. The collar 110 includes a collar port 121 formed through a lower end for fluid communication with chamber 113. Additional collar ports 121 may be provided on the collar 110. For example, a second collar port 122 is disposed through a side wall of the collar 110.

The valve assembly 100 includes a closure member for operating the relief ports 115. An exemplary closure member is an annular closure sleeve 120. The closure sleeve 120 is movably disposed in the chamber 113. As shown, the closure sleeve 120 is biased in the closed position using a biasing member 135. Exemplary biasing members include a coil spring or a wave spring. The biasing member 135 may be configured to retract in response to a force near or below the collapse rating of the casing 20 or burst rating of casing 10. In the closed position, the closure sleeve 120 blocks fluid communication through the relief ports 115. However, the portion of the chamber 113 above the closure sleeve 120 may fluidly communicate with the bore 101 through a vent port 119. Seals 131 such o-rings may be positioned on the body 105 or the closure sleeve 120 for sealing contact with the closure sleeve 120 or the body 105, respectively. Additionally, a seal 132 may be positioned on the closure sleeve 120 or the collar 110 for sealing contact with the collar 110 or the closure sleeve 120, respectively. If a second collar port 122 is used, the seal 132 is preferably disposed above the second collar port 122.

Referring back to FIG. 1, the valve assembly 100 may be operable to control fluid communication between the annulus A and the annulus B. The annulus A surrounds the valve assembly 100, and the annulus B is in fluid communication with the bore 101 of the valve assembly 100. FIG. 2 shows the valve assembly 100 in the closed position.

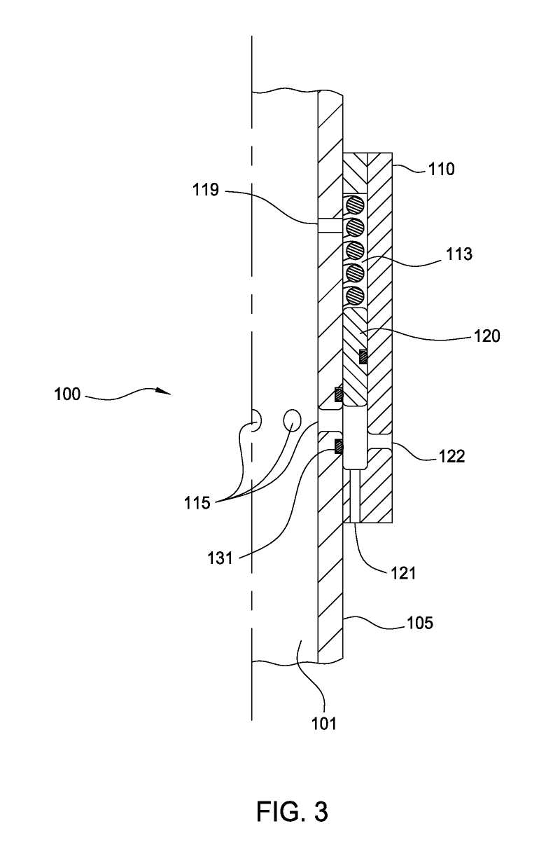

During operation, pressure in the annulus A may act on the closure sleeve 120 via the first collar port 121 to move the closure sleeve 120 against the force of the biasing member 135. When the pressure in annulus A overcomes the biasing force plus force generated from pressure within casing communicated via port 119, the closure sleeve 120 is retracted to expose the relief ports 115. FIG. 3 shows the valve assembly 100 in the open position. Pressurized fluid may flow from the annulus A to the annulus B through the first and second collar ports 121, 122 and the relief ports 115 of the valve assembly 100. The valve assembly 100 is thus operable to relieve and prevent any pressure differential that may cause burst of casing 10 or collapse of the casing 20.

When the pressure in the annulus A decreases below the biasing force of the biasing member 135 plus the pressure in annulus B, the biasing member 135 returns the closure sleeve 120 to the closed position, thereby closing off fluid communication through the relief ports 115. In this manner, the valve assembly 100 is operable as a one-way valve in that it will permit fluid flow into the bore 101 of the valve assembly 100 but will prevent fluid flow out of the bore 101 via the relief port 115. The valve assembly 100 is automatically resettable downhole and may be operated multiple times in response to any pressure fluctuations within the wellbore 5.

In another embodiment, the closure sleeve 120 may be held in the open position using a releasable holder. Exemplary releasable holders include a detent, a catch, a collect, or other suitable releasable holding mechanism having a threshold force for releasing an object being held. The releasable holder can releasably hold the closure sleeve 120 in the open position until a predetermined closing pressure differential is reached. In that respect, the predetermined closing pressure differential is lower than the opening pressure differential required to move the closure sleeve 120. In one example, a detent mechanism may include a c-ring coupled to the closure sleeve 120 that engages a shoulder of the collar 110. When moved to the open position, the closure sleeve 120 may move the c-ring across the shoulder with minimal resistance, but when moved to the closed position, the closure sleeve 120 may encounter a greater resistance to move the c-ring across the shoulder. Other detent arrangements may be use with the embodiments described herein.

In operation, the closure sleeve is retracted to expose the relief port when the opening pressure differential is reached; that is, when the pressure in annulus A overcomes the biasing force plus force generated from pressure within casing communicated via port 119. The closure sleeve 120 is held in the open position by the releasable holder until a predetermined closing pressure differential is reached; that is, when the pressure in annulus A is less than the combined force of the biasing force, force from pressure in annulus B, and the force required to release the releasable holder. In this respect, the releasable holder may prevent the closure member 120, 220, 620 from oscillating between the open and closed positions due to minor pressure differential fluctuations.

In another embodiment, the valve assembly uses a piston rod to control the relief port instead of the closure sleeve. In this respect, the annular chamber 113 shown in FIG. 2 is separated into multiple, discreet chambers for housing a respective piston rod. Each piston rod is positioned and configured to block a respective relief port. A biasing member is provided in each chamber to move the piston rod. The chambers have at least one collar port for communicating the pressure in annulus A to the piston rod. Operation of the piston rod embodiment is similar to the embodiment of FIG. 2. When the pressure in annulus A overcomes the force of the biasing member, the relief port is opened to equalize pressure between annulus A and annulus B. When the pressure in annulus A drops below the biasing force, the piston rod is returned to close the relief port.

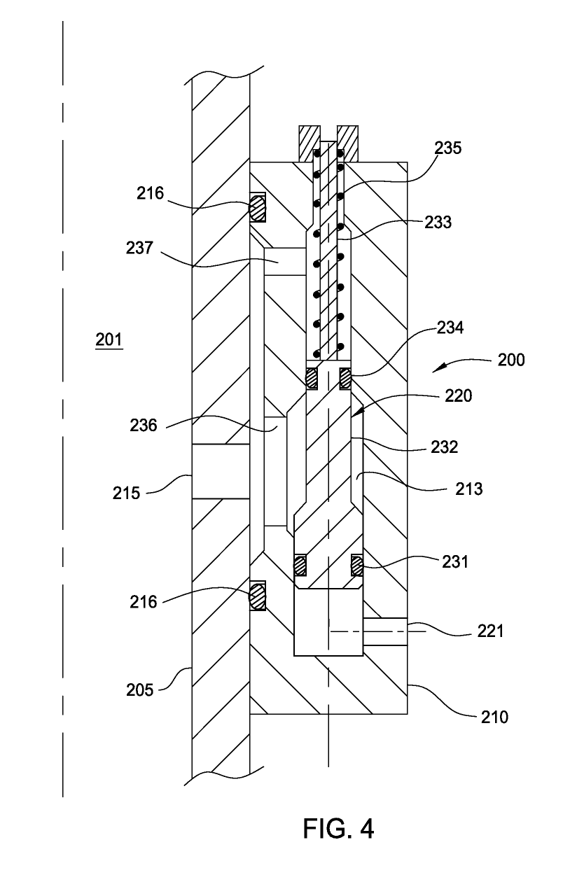

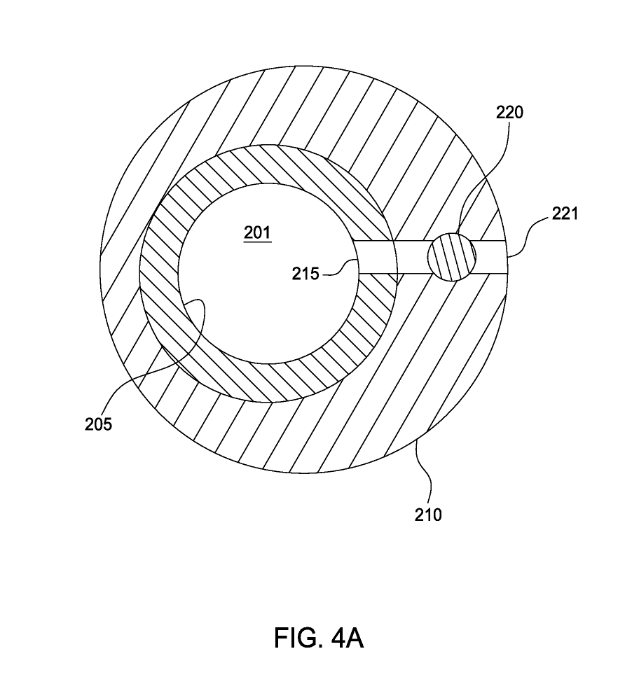

FIG. 4 illustrates another embodiment of a valve assembly 200. The valve assembly 200 is shown in a partial cross-sectional view in a closed position. The valve assembly 200 includes a tubular body 205 connectable to casing 20 to form a part of the casing string. The body 205 has an axial bore 201 and a relief port 215 formed through the wall of the body 205 for fluid communication between an exterior of the casing 20 and an interior of the casing 20. In another embodiment, the body 205 may include a plurality of relief ports 215 circumferentially spaced around the body 205. It must be noted the body 205 may include any suitable number of relief ports, for example, one, two, four, or more ports. Additionally, the body 205 may include multiple ports disposed at different locations along the length of the body 205. Ports disposed at different axial locations on the body 205 may reduce the effect the ports have on the integrity, e.g., tensile strength, of the valve body 205.

A tubular collar 210 is disposed around the outside of the body 205, as shown in FIG. 4. The collar 210 may be attached to the body 205 using a fastener, screw, weld, or other suitable attachment mechanisms. The collar 210 includes a chamber 213 for housing a closure member 220. The chamber 213 can fluidly communicate with the relief port 215 of the body 205. The collar 210 includes a collar port 221 formed through a lower end for fluid communication with chamber 213. Additional collar ports may be provided on the collar 210. Seals 216 such as o-rings may be positioned between the collar 210 and the body 205 to prevent fluid leakage. In one embodiment, the collar 210 is eccentrically positioned around the body 205, as illustrated in FIG. 4A, which is a partial cross-section view of the valve assembly 200 taken across a horizontal plane. Because of the eccentric positioning, the valve assembly 200 has more area on one side of the collar 210 to house the closure member 220. In this respect, the eccentric collar 210 minimizes the area needed for the closure member 220. In another embodiment, the collar 210 is positioned concentrically with the body 205. In yet another embodiment, the collar 210 and the body 205 may be formed as a single piece with one or more valve assemblies 200.

The closure member 220 is used to operate the relief ports 215. An exemplary closure member is a piston 220. The piston 220 includes a piston head 232 and a guide rod 233. The piston head 232 has a larger diameter distal end and smaller diameter proximal end. Seals 231, 234 such as o-rings are provided at each end for sealing engagement with the chamber 213 when in the closed position. The piston 220 is movably disposed in the chamber 213. As shown, the piston 220 is biased in the closed position using a biasing member 235. Exemplary biasing members 235 include a coil spring or a wave spring. The biasing member 235 may be configured to retract in response to a force near or below the burst or collapse rating of the casing 20.

In the closed position, the piston 220 blocks fluid communication through the relief ports 215. However, the relief ports 215 can fluidly communication with a portion of the chamber 213 via a first internal port 236. The first internal port 236 is straddled by the seals 231, 234 at the two ends. Additionally, the relief ports 215 can fluidly communicate with the portion of the chamber 213 above the seal 234 at the proximal end via a second internal port 237. In this respect, fluid pressure in the bore 201 of the body 205 may provide an additional closing force on the piston 220. The second internal port 237 also allows the fluid above the seal 234 to vent when the piston 220 retracts during opening.

Referring back to FIG. 1, the valve assembly 200 may be operable to control fluid communication between the annulus A and the annulus B. The annulus A surrounds the valve assembly 200, and the annulus B is in fluid communication with the bore 201 of the valve assembly 200. FIG. 4 shows the valve assembly 200 in the closed position.

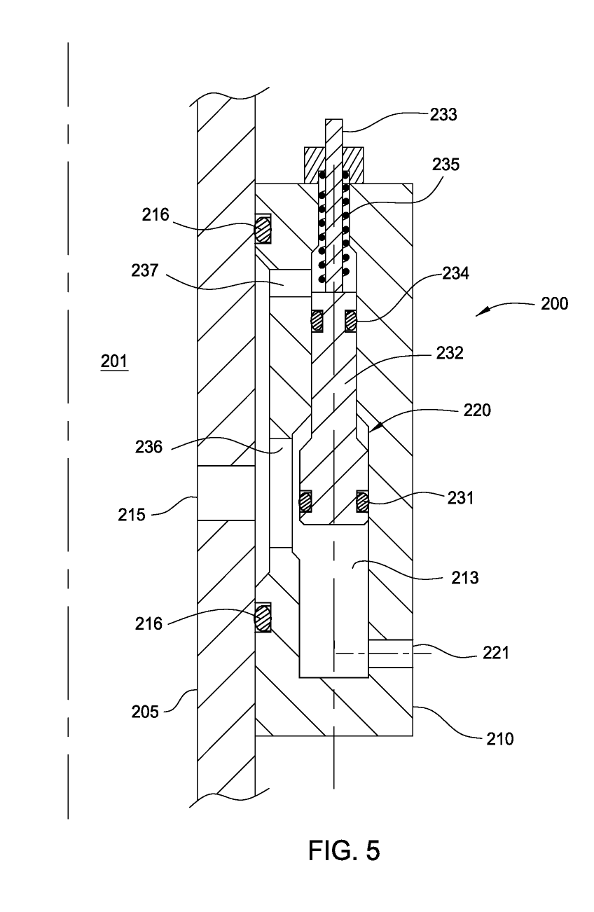

During operation, pressure in the annulus A may act on the piston 220 via the first collar port 221 to move the piston 220 against the force of the biasing member 235 and the pressure in annulus B acting on the piston 220 via the first and second internal ports 236, 237. When the pressure in annulus A overcomes the biasing force and the annulus B pressure, the piston 220 is retracted to expose the relief ports 215. FIG. 5 shows the valve assembly 200 in the open position. Pressurized fluid may flow from the annulus A to the annulus B through the collar port 221, the first and second internal ports 236, 237, and the relief port 215 of the valve assembly 200. The valve assembly 200 is thus operable to relieve and prevent any pressure differential that may cause burst or collapse of the casings 10, 20.

When the force on piston 220 due to pressure in the annulus A decreases below the sum of the force on piston 220 due to pressure in annulus B plus the biasing force of the biasing member 235, the biasing member 235 returns the piston 220 to the closed position, thereby closing off fluid communication through the relief port 215. In this manner, the valve assembly 200 is operable as a one-way valve in that it will permit fluid flow into the bore 201 of the valve assembly 200 but will prevent fluid flow out of the bore 201 via the relief port 215. The valve assembly 200 is automatically resettable downhole and may be operated multiple times in response to any pressure fluctuations within the wellbore 5. As stated above, any of the casings 10, 20, 30 and/or the tubular members 40, 45 may each be provided with one or more valve assemblies 200 to allow fluid flow from a surrounding casing or tubular member to an inner casing or tubular member, while preventing fluid flow in the opposite direction.

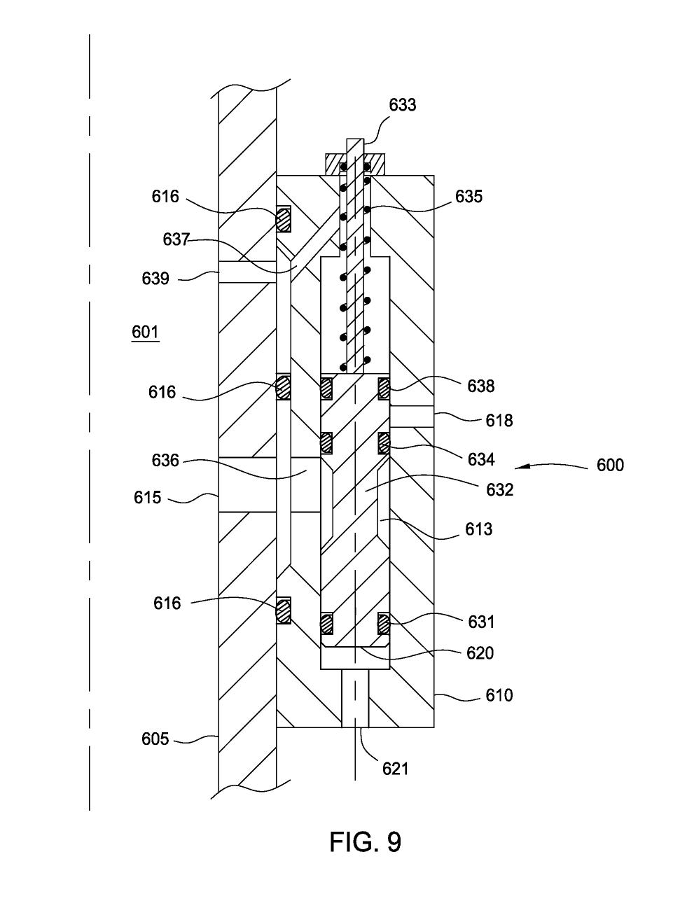

FIG. 9 illustrates another embodiment of a valve assembly 600. The valve assembly 600 is shown in a partial cross-sectional view in a closed position. The valve assembly 600 includes a tubular body 605 connectable to casing 20 to form a part of the casing string. The body 605 has an axial bore 601 and a relief port 615 formed through the wall of the body 605 for fluid communication between an exterior of the casing 20 and an interior of the casing 20. In another embodiment, the body 605 may include a plurality of relief ports 615 circumferentially spaced around the body 605. It must be noted the body 605 may include any suitable number of relief ports, for example, one, two, four, or more ports. Additionally, the body 605 may include multiple ports disposed at different locations along the length of the body 605. Ports disposed at different axial locations on the body 605 may reduce the effect the ports have on the integrity, e.g., tensile strength, of the valve body 605.

A tubular collar 610 is disposed around the outside of the body 605, as shown in FIG. 9. The collar 610 may be attached to the body 605 using a fastener, screw, weld, or other suitable attachment mechanisms. The collar 610 includes a chamber 613 for housing a closure member 620. The chamber 613 can fluidly communicate with the relief port 615 of the body 605. The collar 610 includes a collar port 621 formed through a lower end for fluid communication with chamber 613. The collar port 621 may be used to communicate the pressure in annulus A to the closure member 620. Additional collar ports may be provided on the collar 610. Seals 616 such as o-rings may be positioned between the collar 610 and the body 605 to prevent fluid leakage. The collar 610 also includes inflow port 618 for fluid communication with the relief port 615. The inflow port 618 is blocked by the closure member 620 when in the closed position. In one embodiment, the collar 610 is eccentrically positioned around the body 605. In another embodiment, the collar 610 is positioned concentrically with the body 605. In yet another embodiment, the collar 610 and the body 605 may be integrally formed as a single piece with one or more valve assemblies 600.

The closure member 620 is used to operate the relief ports 615. An exemplary closure member is a piston 620. The piston 620 includes a piston head 632 and a guide rod 633. The piston head 632 has a smaller diameter middle section. Seals 631, 634, 638 such as o-rings are provided at each end for sealing engagement with the chamber 613 when in the closed position. As shown, seals 634 and 638 are positioned to close off the inflow port 618. The piston 620 is movably disposed in the chamber 613. As shown, the piston 620 is biased in the closed position using a biasing member 635. Exemplary biasing members 635 include a coil spring or a wave spring. The biasing member 635 may be configured to retract in response to a force near or below the burst or collapse rating of the casing 20.

In the closed position, the piston 620 blocks fluid communication through the relief ports 615. However, the relief ports 615 can fluidly communication with a portion of the chamber 613 via a first internal port 636. The first internal port 636 is straddled by the seals 631, 634 at the two ends. Additionally, the bore 601 can fluidly communicate with the portion of the chamber 613 above seal 638 at the proximal end via a second internal port 637 and vent port 639. In this respect, fluid pressure in the bore 601 of the body 605 may provide an additional closing force on the piston 620. The second internal port 637 also allows the fluid above the seal 638 to vent when the piston 620 retracts during opening.

Referring back to FIG. 1, the valve assembly 600 may be operable to control fluid communication between the annulus A and the annulus B. The annulus A surrounds the valve assembly 600, and the annulus B is in fluid communication with the bore 601 of the valve assembly 600. FIG. 9 shows the valve assembly 600 in the closed position.

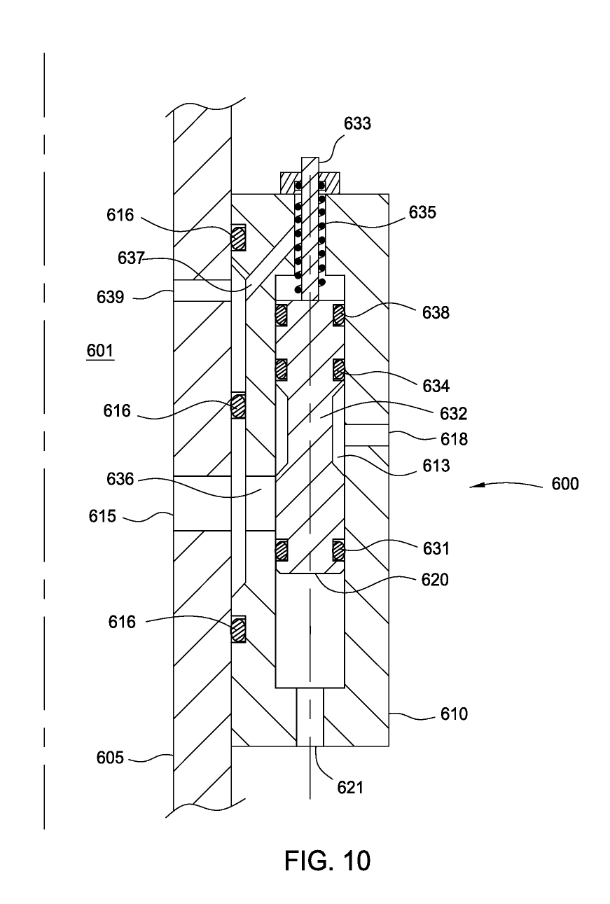

During operation, pressure in the annulus A may act on the piston 620 via the first collar port 621 to move the piston 620 against the force of the biasing member 635 and the pressure in annulus B acting on the piston 620 via the first and second internal ports 636, 637. When the pressure in annulus A overcomes the biasing force and the annulus B pressure, the piston 620 is retracted to open the inflow port 618 and place the inflow port 618 in fluid communication with the relief ports 615. FIG. 10 shows the valve assembly 600 in the open position. Pressurized fluid may flow from the annulus A to the annulus B through the inflow port 618, the first internal port 636, and the relief port 615 of the valve assembly 600. Fluid from the collar port 621 is blocked from communication with the relief port 615 by the lower seal 631. The valve assembly 600 is thus operable to relieve and prevent any pressure differential that may cause burst or collapse of the casings 10, 20.

When the force on piston 620 due to pressure in the annulus A decreases below the sum of the force on piston 620 due to pressure in annulus B plus the biasing force of the biasing member 635, the biasing member 635 returns the piston 620 to the closed position, thereby closing off fluid communication through the relief port 615. In this manner, the valve assembly 600 is operable as a one-way valve in that it will permit fluid flow into the bore 601 of the valve assembly 600 but will prevent fluid flow out of the bore 601 via the relief port 615. The valve assembly 600 is automatically resettable downhole and may be operated multiple times in response to any pressure fluctuations within the wellbore 5. As stated above, any of the casings 10, 20, 30 and/or the tubular members 40, 45 may each be provided with one or more valve assemblies 600 to allow fluid flow from a surrounding casing or tubular member to an inner casing or tubular member, while preventing fluid flow in the opposite direction.

In any of the embodiments described herein, the closure member 120, 220, 620 may be held in the open position using a releasable holder as described above. The releasable holder can releasably hold the closure member 120, 220, 620 in the open position until a predetermined closing pressure differential is reached. In that respect, the predetermined closing pressure differential is lower than the opening pressure differential required to move the closure member 120, 220, 620. In one example, a detent mechanism may include a c-ring coupled to the piston 620 that engages a shoulder of the collar 610. When moved to the open position, the piston 620 may move the c-ring across the shoulder with minimal resistance, but when moved to the closed position, the piston 620 may encounter a greater resistance to move the c-ring across the shoulder. Other detent arrangements may be use with the embodiments described herein.

In operation, the closure member 120, 220, 620 is retracted to expose the relief port when the opening pressure differential is reached; that is, when the pressure in annulus A overcomes the biasing force plus force generated from pressure with casing communicated via port. The closure member 120, 220, 620 is held in the open position by the releasable holder until a predetermined closing pressure differential is reached. In this respect, the releasable holder may prevent the closure member 120, 220, 620 from oscillating between the open and closed positions due to minor pressure differential fluctuations.

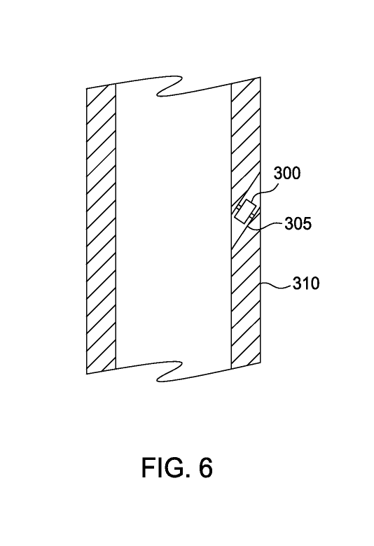

In yet another embodiment, a pressure relief valve may be sized for positioning in a hole formed through a wall of the casing or an enlarged section of the casing. In the embodiment shown in FIG. 6, the pressure relief valve 300 is disposed in a hole 305 drilled into the wall of the casing 310 to limit the pressure differential between the outside of the casing and the inside of casing. When the pressure differential reaches a predetermined differential, such as near the collapse pressure of the casing, the pressure relief valve opens to allow equalization of the pressure between the inside and the outside. The hole may be formed in any suitable manner know to a person of ordinary skill. For example, the hole may be drilled diagonally or parallel to the axis of the tubular and ported to the inner diameter and the outer diameter of the collar.

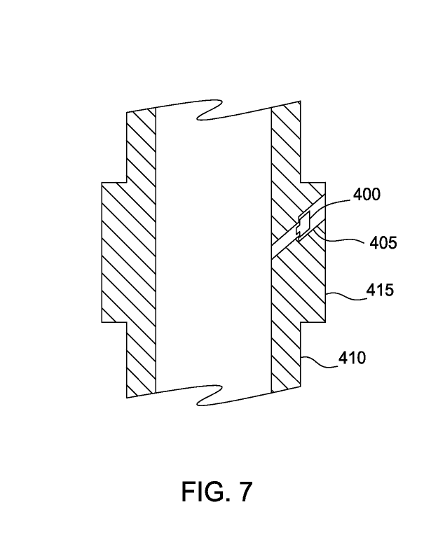

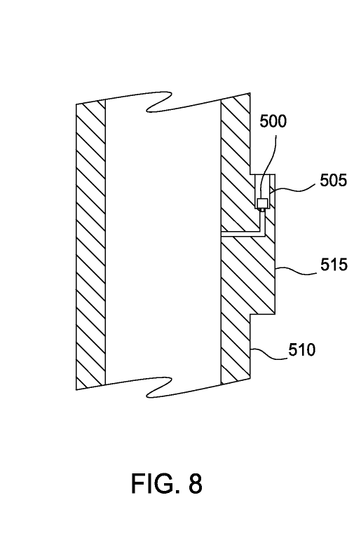

In FIG. 7, the pressure relief valve 400 is disposed in a hole 405 drilled diagonally through an enlarged diameter section 415 of the casing 410. The hole 405 may have a shoulder leading to a smaller diameter hole for seating the pressure relief valve 400. In FIG. 8, the hole 505 for receiving the pressure relief valve 500 is drilled parallel to the axis of the casing 510. The hole 505 is formed in an enlarged, eccentric section 515 of the casing 510, wherein the non-enlarged section does not share a common central axis with the enlarged section. The hole 505 intersects a bore in communication with the interior of the casing 510. It must be noted that any hole described with respect to a specific casing section may also be formed in a different type of casing section. For example, the hole 505 shown in FIG. 8 may be formed in an enlarged, concentric section of the casing 510. An exemplary pressure relief valve is commercially available from Ausco Inc. The pressure relief valve may be rated for up to 10,000 psi activating pressure and allow flow rates up to 40 gallons per minute.

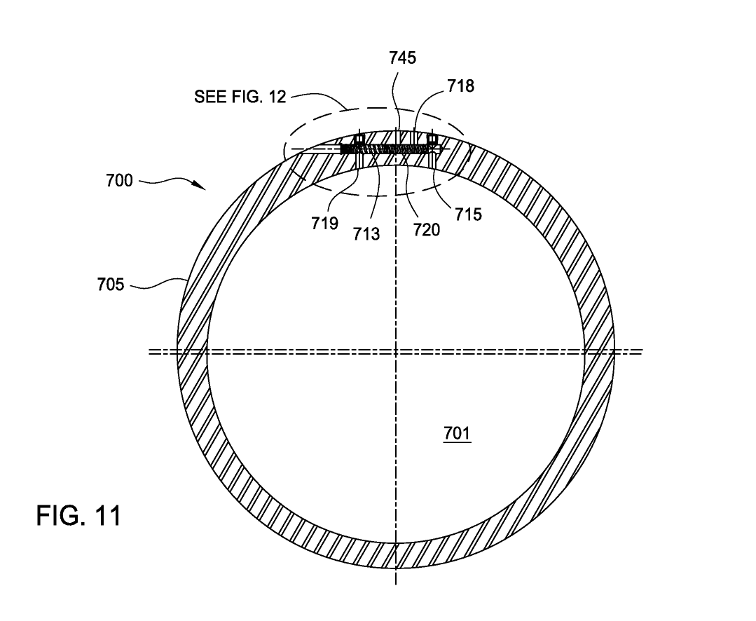

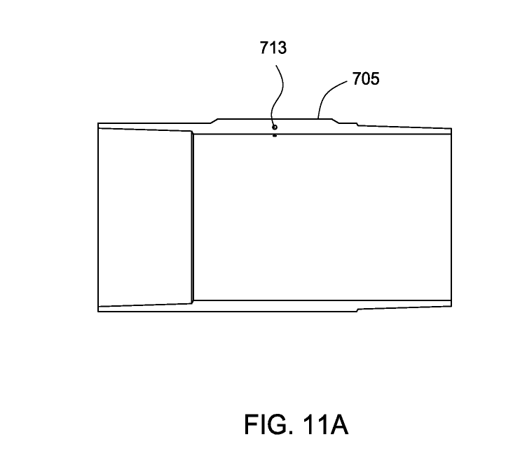

FIG. 11 is a cross-sectional view of an exemplary valve assembly 700 positioned in a wall of a tubular body 705. FIG. 11A is a longitudinal cross-sectional view of the tubular body 705 containing the valve assembly 700. The tubular body 705 has an axial bore 701 formed therethrough and may include threads for connection to a tubular such as casing 20. In another embodiment, the tubular body may be integral with the casing. In yet another embodiment, the valve assembly 700 may be disposed in an enlarged section of a tubular body.

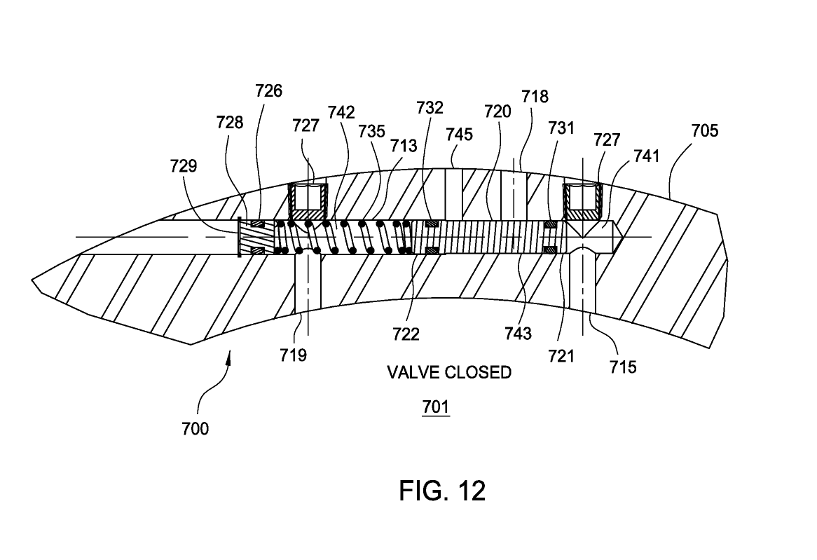

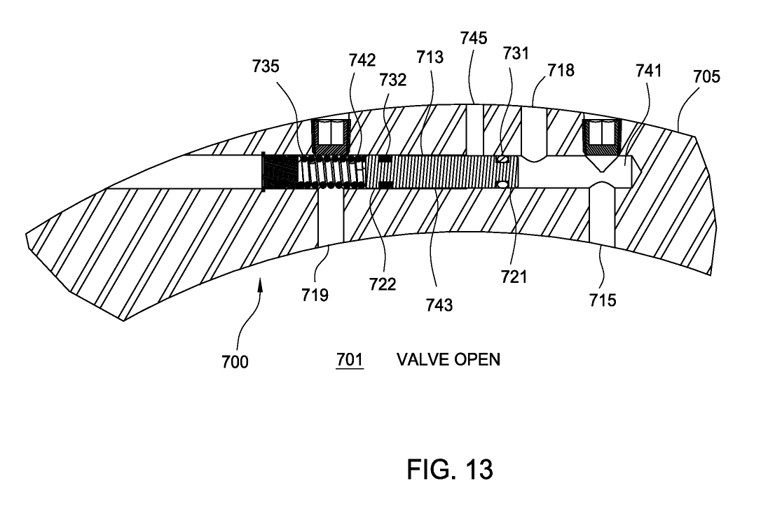

FIGS. 12 and 13 are enlarged cross-sectional views of the valve assembly 700 in the closed position and the open position, respectively. The tubular body 705 has a relief port 715 formed through the wall of the body 705 for selective fluid communication between an exterior of the casing 20 and an interior of the casing 20. In another embodiment, the body 705 may include a plurality of valve assemblies circumferentially spaced around the body 705. Additionally, the body 705 may include multiple valve assemblies disposed at different locations along the length of the body 705. Valve assemblies disposed at different axial locations on the body 705 may reduce the effect the valve assemblies have on the integrity, e.g., tensile strength, of the valve body 705. In yet another embodiment, the valve assemblies may be positioned in an enlarged, concentric or eccentric section of the tubular body. Placement of the valve assembly in the enlarged cross section of the concentric or eccentric section may offset the effects on tensile strength, burst resistance, and collapse resistance on the body.

The tubular body 705 includes a chamber 713 for housing a closure member 720. The closure member 720 is used to operate the relief port 715. An exemplary closure member is a piston 720. In one embodiment, the piston 720 includes a first portion 721 having a smaller diameter than a second portion 722. A seal 731, 732 is disposed around each of the first and second portions 721, 722 of the piston 720 for sealing engagement with the chamber 713. An exemplary seal is an o-ring. The piston 720 is movably disposed in the chamber 713 to operate the valve. As shown, the piston 720 is biased in the closed position using a biasing member 735. Exemplary biasing members 735 include a coil spring or a wave spring. The biasing member 735 may be configured to retract in response to a force near or below the burst or collapse rating of the casing 20. One or more plugs may optionally be used to enclose the chamber 713. In the embodiment as shown, three plugs 727, 728 are used to close off openings in the tubular body 705 formed during manufacture of the valve assembly 700. The plugs 727, 728 may optionally include a seal 726, a retaining ring 729, or both.

In one embodiment, the chamber 713 can fluidly communicate with the relief port 715 and a chamber port 719 of the body 705. The relief port 715 allows fluid communication between the bore 701 and the portion 741 of the chamber 713 defined by the first seal 731. The chamber port 719 allows fluid communication between the bore 701 and the portion 742 of the chamber 713 defined by the second seal 732. An inflow port 718 and an actuation port 745 allow fluid communication between the exterior of the tubular body 705 and the portion 743 of the chamber 713 between the first seal 731 and the second seal 732. In this respect, these ports 718, 745 are blocked from fluid communication with the bore by the closure member 720 when the valve assembly 700 is in the closed position. The inflow port 718 and the actuation port 745 are positioned such that in the open position, the inflow port 718 is allowed to communicate with the relief port 715, and the actuation port 745 remains blocked from communication with the bore 701.

Referring back to FIG. 1, the valve assembly 700 may be operable to control fluid communication between the annulus A and the annulus B. The annulus A surrounds the valve assembly 700, and the annulus B is in fluid communication with the bore 601 of the valve assembly 700.

FIG. 12 shows the valve assembly 700 in the closed position. During operation, the biasing member 735 and the pressure in annulus B are acting on the piston 720 to keep the valve assembly closed. The pressure in annulus B is acting on both sides of the piston 720 via the relief port 715 and the chamber port 719. Because the second portion 722 of the piston 720 has a larger diameter than the first portion 721, the pressure in annulus B has an overall effect of urging piston 720 to the closed position. The pressure in annulus A may act on the piston 720 via the actuation port 745. The annulus A pressure acts on a tapered section of the piston 720 where the diameter changes to urge the piston 720 toward the open position.

When the pressure in annulus A is sufficient to overcome the biasing force and the force from the annulus B pressure, the piston 720 is retracted to open the inflow port 718 and place the inflow port 718 in fluid communication with the relief port 715. FIG. 13 shows the valve assembly 700 in the open position. As shown, the piston 720 has moved to a position where the first seal 731 is disposed between the actuation port 745 and the inflow port 718. Pressurized fluid may flow from the annulus A to the annulus B through the inflow port 718, the chamber 713, and the relief port 715 of the valve assembly 700. Fluid from the actuation port 745 is blocked from communication with the relief port 715 by the first seal 731. The valve assembly 700 is thus operable to relieve and prevent any pressure differential that may cause burst or collapse of the casings 10, 20.

When the force on piston 720 due to pressure in the annulus A decreases below the sum of the force on piston 720 due to pressure in annulus B plus the biasing force of the biasing member 735, the biasing member 735 returns the piston 720 to the closed position, thereby closing off fluid communication through the relief port 715. In this manner, the valve assembly 700 is operable as a one-way valve in that it will permit fluid flow into the bore 701 of the valve assembly 700 but will prevent fluid flow out of the bore 701 via the relief port 715. The valve assembly 700 is automatically resettable downhole and may be operated multiple times in response to any pressure fluctuations within the wellbore 5. As stated above, any of the casings 10, 20, 30 and/or the tubular members 40, 45 may each be provided with one or more valve assemblies 700 to allow fluid flow from a surrounding casing or tubular member to an inner casing or tubular member, while preventing fluid flow in the opposite direction.

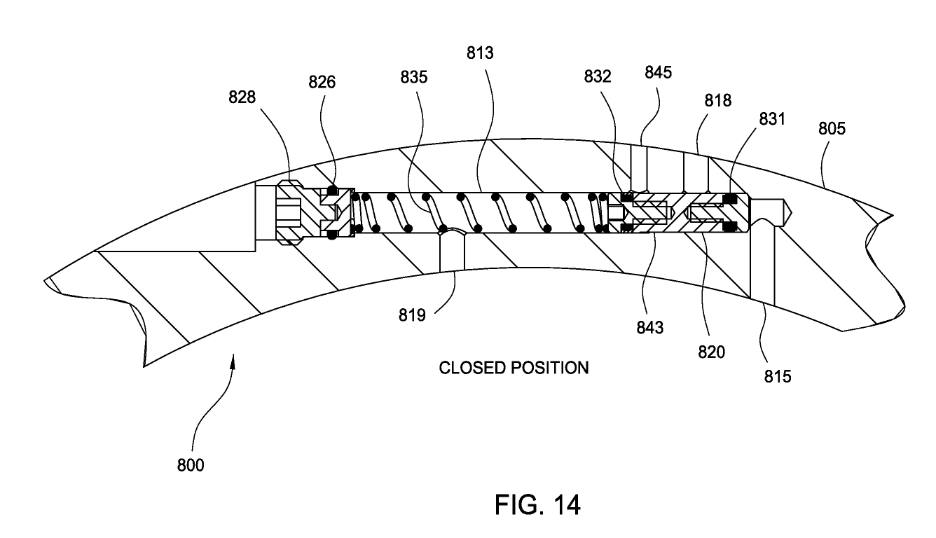

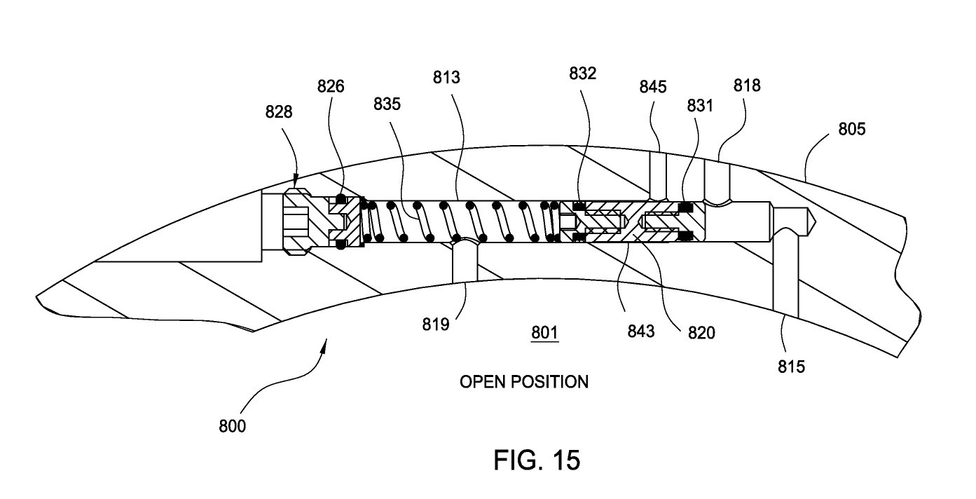

FIGS. 14 and 15 are cross-sectional views of another exemplary embodiment of a valve assembly 800 positioned in a wall of a tubular body 805. FIG. 14 shows the valve assembly 800 in the closed position, and FIG. 15 shows the valve assembly 800 in the open position. The tubular body 805 may be the tubular body 705 shown in FIG. 11A. The tubular body 805 has an axial bore 801 formed therethrough and may include threads for connection to a tubular such as casing 20. In another embodiment, the tubular body 805 may be integral with the casing 20. In yet another embodiment, the valve assembly 800 may be disposed in an enlarged section of a tubular body 805.

Referring to FIG. 14, the tubular body 805 has a relief port 815 formed through the wall of the body 805 for selective fluid communication between an exterior of the body 805 and an interior of the body 805. In another embodiment, the body 805 may include a plurality of valve assemblies circumferentially spaced around the body 805. Additionally, the body 805 may include multiple valve assemblies disposed at different locations along the length of the body 805. Valve assemblies disposed at different axial locations on the body 805 may reduce the effect the valve assemblies have on the integrity, e.g., tensile strength, of the valve body 805. In yet another embodiment, the valve assemblies may be positioned in an enlarged, concentric or eccentric section of the tubular body. Placement of the valve assembly in the enlarged cross section of the concentric or eccentric section may offset the effects on tensile strength, burst resistance, and collapse resistance on the body.

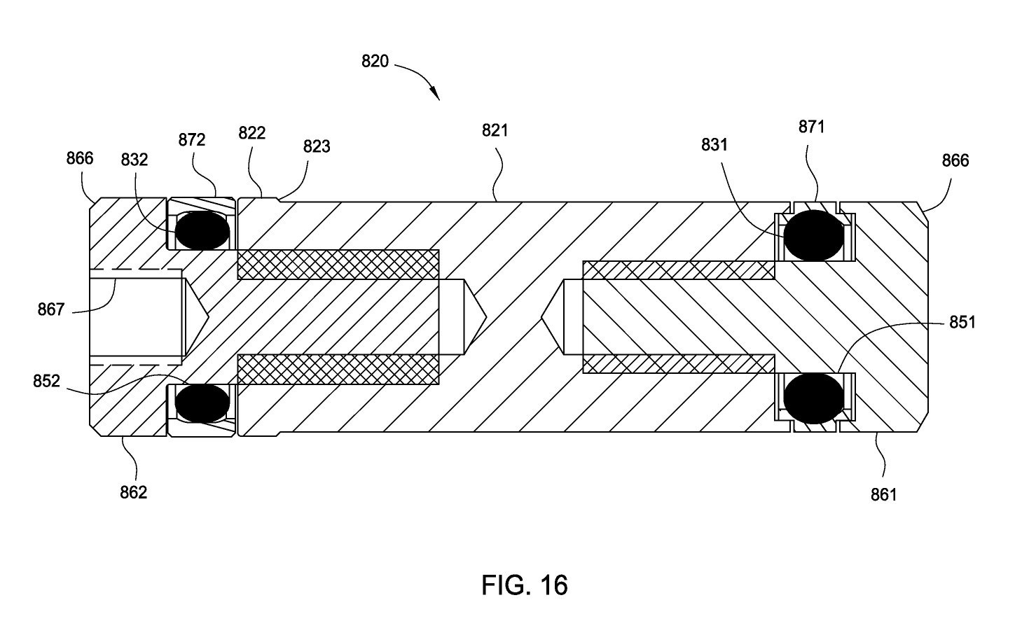

The tubular body 805 includes a chamber 813 for housing a closure member 820. The closure member 820 is used to operate the relief port 815. An exemplary closure member is a piston 820, as illustrated in FIG. 16. In one embodiment, the piston 820 includes a first portion 821 having a smaller diameter than a second portion 822. A shoulder 823 is formed at the interface between the first portion 821 and the second portion 822. A seal 831, 832 is disposed around each of the first and second portions 821, 822 of the piston 820 for sealing engagement with the chamber 813. An exemplary seal is an o-ring. In one embodiment, the seals 831, 832 may be disposed in a recess 851, 852 of the respective portions 821, 822 of the piston 820. The seals 831, 832 may be exposed for direct engagement with the chamber 813. The piston 820 may include releasable end segments 861, 862 to facilitate installation of the seals 831, 832 in the recesses 851, 852. For example, the end segments 861, 862 may be configured to form the recesses 851, 852 when connected to the respective first and second portions 821, 822 of the piston 820. The seals 831, 832 are installed before the end segments 861, 862 are connected to piston 820. The end segments 861, 862 may be connected using threads, interference fit, and other suitable connection mechanisms. The end segments 861, 862 may optionally include beveled corners 866. The second end segment 862 may optionally include a retrieval receptacle 867 for receiving a retrieval tool to facilitate removal of the piston 820 from the chamber 813.

In another embodiment, optional cap seals 871, 872 may be disposed around the seals 831, 832. The cap seals 871, 872 may be manufactured from a material having a lower frictional property than the material of the seals 831, 832. Exemplary cap seal materials include polytetrafluorethylene such as Teflon® and thermoplastics such as PEEK. The cap seals 871, 872 may have an annular shape and configured to receive an o-ring seal at its inner surface. The cap seals 871, 872 may prevent extrusion of the o-ring seals during use. The seals 831, 832 may be made from a polymer and may energize the cap seals 871, 872. In another embodiment, the cap seal 871 may include shoulders adapted to engage protrusions that extend into the recess 851. As such, the shoulders and protrusions may prevent extrusion of the cap seal 871. It must be noted that although two different embodiments of the cap seals are shown, the two cap seals 871, 872 on the piston 820 may be the same or different embodiments. Additionally, one or both of the seals 831, 832 may be provided with an optional cap seal; for example, seal 832 is not provided with a cap seal 872, and seal 831 is provided with a cap seal 871.

Referring back to FIG. 14, the piston 820 is movably disposed in the chamber 813 to operate the valve. As shown, the piston 820 is biased in the closed position using a biasing member 835. Exemplary biasing members 835 include a coil spring or a wave spring. The biasing member 835 may be configured to retract in response to a force near or below the burst or collapse rating of the casing 20.

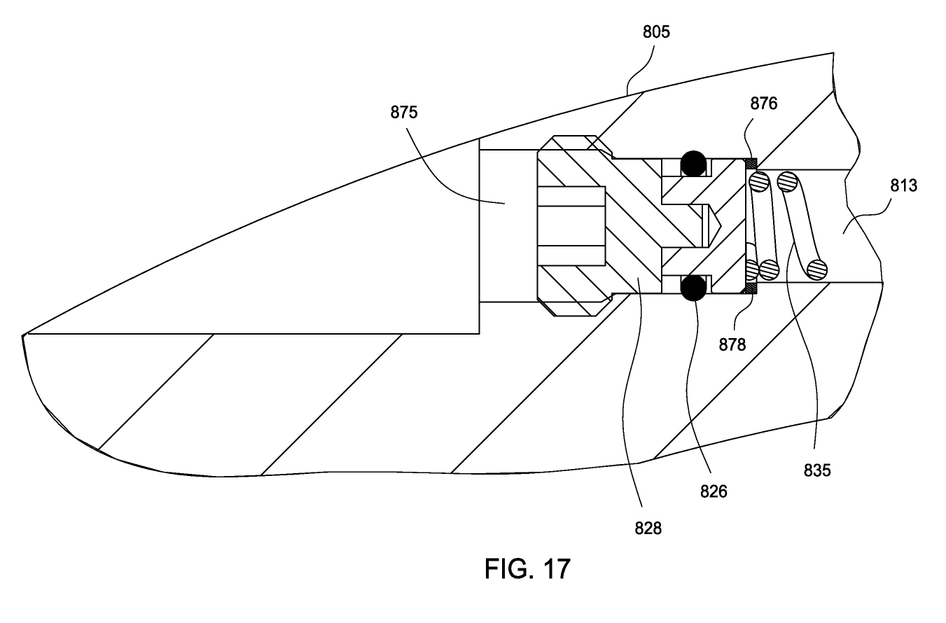

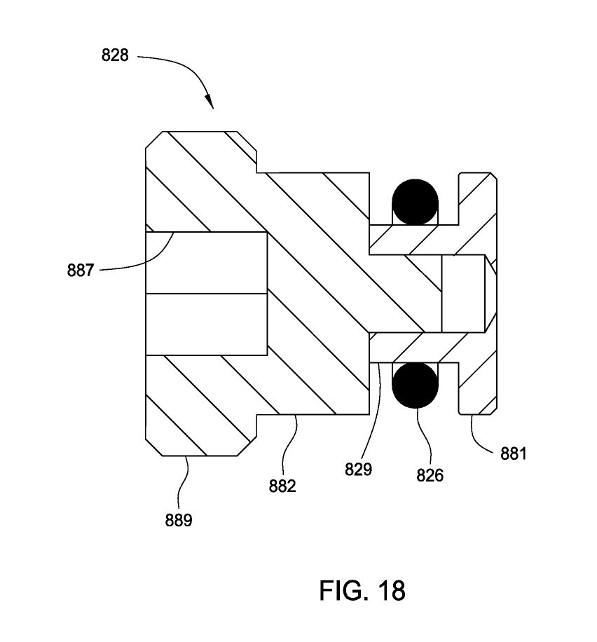

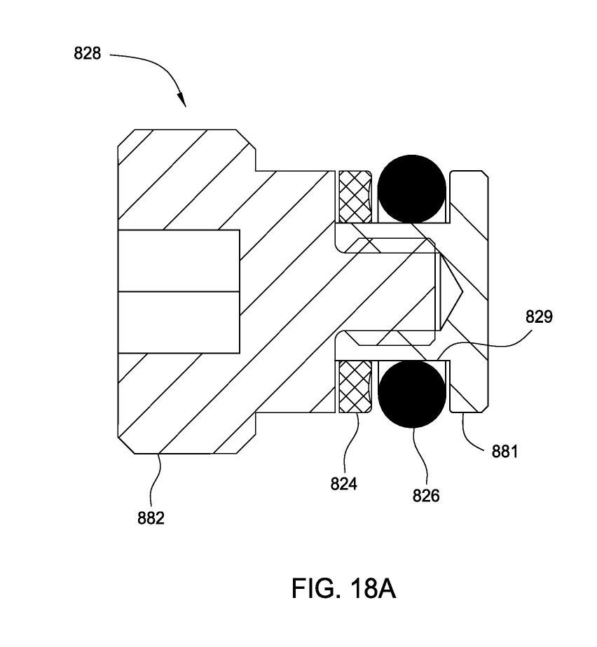

A plug 828 is provided to engage the other end of the biasing member 835 and to enclose the chamber 813. FIG. 17 is an enlarged partial view of the valve assembly 800 showing the plug 828. The plug 828 is disposed in an opening 875 of the tubular body 805 that leads to the chamber 813. As shown, the opening 875 has a larger diameter than the chamber 813, thereby forming a shoulder 876 at the interface. In another embodiment, the opening may have the same or different diameter than the chamber 813. The plug 828 may optionally include a seal 826 to prevent communication through the opening 875. FIG. 18 is an exemplary embodiment of the plug 828. The plug 828 may include a recess 829 for receiving the seal 826. The plug 828 may separate into two sections 881, 882 at the recess 829 to facilitate installation of the seal 826. The two sections 881, 882 may be connected using threads, interference fit, and other suitable connection mechanisms. The front section 881 may be sized with an outer diameter that is larger than the diameter of the chamber 813, thereby engaging the shoulder 876. The body section 882 may optionally a retrieval receptacle 887 for receiving a retrieval tool to facilitate removal of the plug 828 from the opening 875. In another embodiment, the body section 882 may include a larger diameter head portion 889. The head portion 889 may include threads for attachment to the opening 875. In addition to threads, it is contemplated that the plug 828 may attach to the opening 875 using an interference fit, a locking mechanism such as a pin or screw, or any suitable attachment mechanism. FIG. 18A illustrates another embodiment of the plug 828. As shown, the plug 828 includes a backup ring disposed the recess 829 and adjacent to the seal 826. In another embodiment, the seal 826 may be provided with a cap seal (871 or 872) as shown in FIG. 16.

In one embodiment, the valve assembly 800 includes an adjustable activation pressure feature. Referring again to FIGS. 14 and 17, the opening force may be adjusted by changing the distance between the plug 828 and the piston 820 in the closed position. The change in distance, in turn, changes the force required to compress the biasing member 835, thereby retracting the piston 820 to the open position. In one embodiment, the plug 828 is threadedly connected to the opening 875. The threads allow adjustment of the distance between the plug 828 and the piston 820. In another embodiment, after the plug 828 is positioned at the proper distance from the piston 820, a locking device such as a pin or a screw may be inserted to fix the location of the plug 828. The opening may have a series of holes at different axial locations to receive the locking device. To facilitate installation of the plug 828, one or more optional spacer rings 878 may be disposed between the plug 828 and the shoulder 876. The spacer rings 878 have an inner diameter that is larger than the outer diameter of the biasing member 835. In this respect, the biasing member 835 may extend into the spacer ring 878. The spacer ring 878 may thus function as a centralizer such that the biasing member 835 is centrally contained. The axial length of the rings 878 is determined by the required activation force. For example, if lower activation force is needed a longer spacer ring 878 or more spacer rings 878 are used. If a higher activation force is needed, a shorter spacer ring 878 or fewer spacer rings 878 are used to decrease the distance between the plug 828 and the piston 820. After positioning the spacer ring 878 in the opening, the plug 828 is threaded down until it contacts the spacer ring 878. In this manner, adjusting the distance may be performed by changing the length of the spacer ring 878 instead of rotating the plug 828 to the proper location.

Referring to FIG. 14, the chamber 813 can fluidly communicate with the relief port 815 and a chamber port 819 of the body 805. The relief port 815 allows fluid communication between the bore 801 and the portion 841 of the chamber 813 in front of the first seal 831. The chamber port 819 allows fluid communication between the bore 801 and the portion 842 of the chamber 813 defined by the second seal 832 and the plug 828. An inflow port 818 and an actuation port 845 allow fluid communication between the exterior of the tubular body 805 and the portion 843 of the chamber 813 between the first seal 831 and the second seal 832. These ports 818, 845 are blocked from fluid communication with the bore 801 by the closure member 820 when the valve assembly 800 is in the closed position. The inflow port 818 and the actuation port 845 are positioned such that in the open position, the inflow port 818 is allowed to communicate with the relief port 815, and the actuation port 845 remains blocked from communication with the bore 801.

Referring back to FIG. 1, the valve assembly 800 may be operable to control fluid communication between the annulus A and the annulus B. The annulus A surrounds the valve assembly 800, and the annulus B is in fluid communication with the bore 801 of the valve assembly 800.

FIG. 14 shows the valve assembly 800 in the closed position. During operation, the biasing member 835 and the pressure in annulus B are acting on the piston 820 to keep the valve assembly 800 closed. The pressure in annulus B is acting on both sides of the piston 820 via the relief port 815 and the chamber port 819. Because the second portion 822 of the piston 820 has a larger diameter than the first portion 821, the pressure in annulus B has an overall effect of urging piston 820 to the closed position. The pressure in annulus A may act on the piston 820 via the actuation port 845. The annulus A pressure acts on a tapered section 823 of the piston 820 where the diameter changes to urge the piston 820 toward the open position.

When the pressure in annulus A is sufficient to overcome the biasing force of the biasing member 835 and the force from the annulus B pressure, the piston 820 is retracted to open the inflow port 818 and place the inflow port 818 in fluid communication with the relief port 815. FIG. 15 shows the valve assembly 800 in the open position. In one embodiment, the activation force required to open the inflow port 818 is set below the burst pressure of the casing 20. As shown, the piston 820 has moved to a position where the first seal 831 is disposed between the actuation port 845 and the inflow port 818. Pressurized fluid is allowed to flow from annulus A to annulus B through the inflow port 818, the chamber 813, and the relief port 815 of the valve assembly 800. Fluid from the actuation port 845 is blocked from communication with the relief port 815 by the first seal 831 and continues to supply the force to keep the valve assembly 800 open. After opening, it is believed that the fluid flowing from annulus A may also act on the front of the piston 820 to help keep the valve assembly 800 in the open position. The valve assembly 800 is thus operable to relieve and prevent any pressure differential that may cause burst or collapse of the casings 10, 20.

When the force on piston 820 due to pressure in the annulus A falls below the sum of the force on piston 820 due to pressure in annulus B plus the biasing force of the biasing member 835, the biasing member 835 returns the piston 820 to the closed position, thereby closing off fluid communication through the relief port 815. In this manner, the valve assembly 800 is operable as a one-way valve in that it will permit fluid flow into the bore 801 of the valve assembly 800 but will prevent fluid flow out of the bore 801 via the relief port 815. The valve assembly 800 is automatically resettable downhole and may be operated multiple times in response to any pressure fluctuations within the wellbore 5. As stated above, any of the casings 10, 20, 30 and/or the tubular members 40, 45 may each be provided with one or more valve assemblies 800 to allow fluid flow from a surrounding casing or tubular member to an inner casing or tubular member, while preventing fluid flow in the opposite direction.

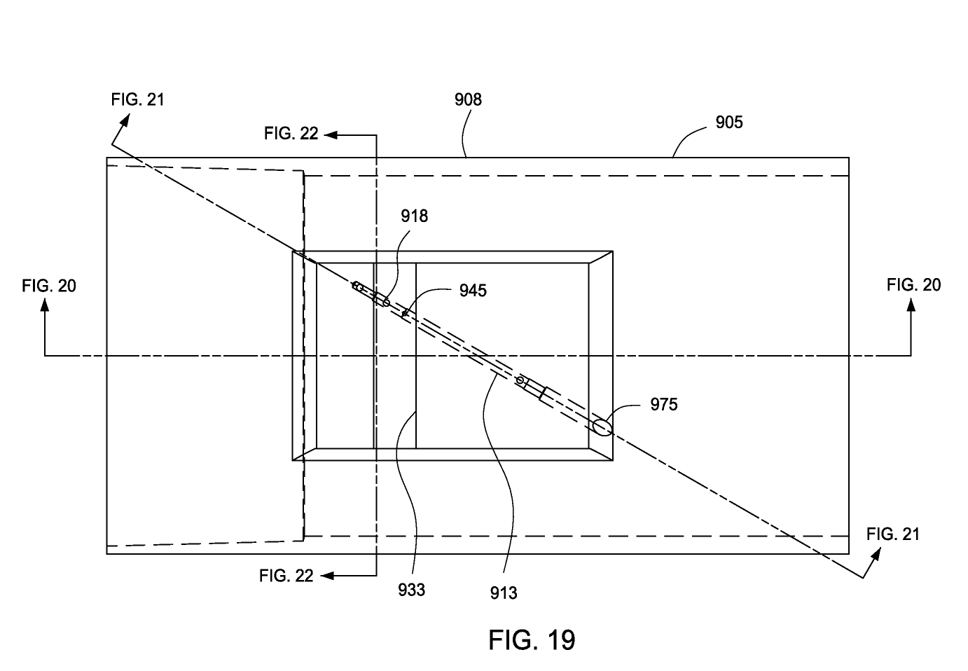

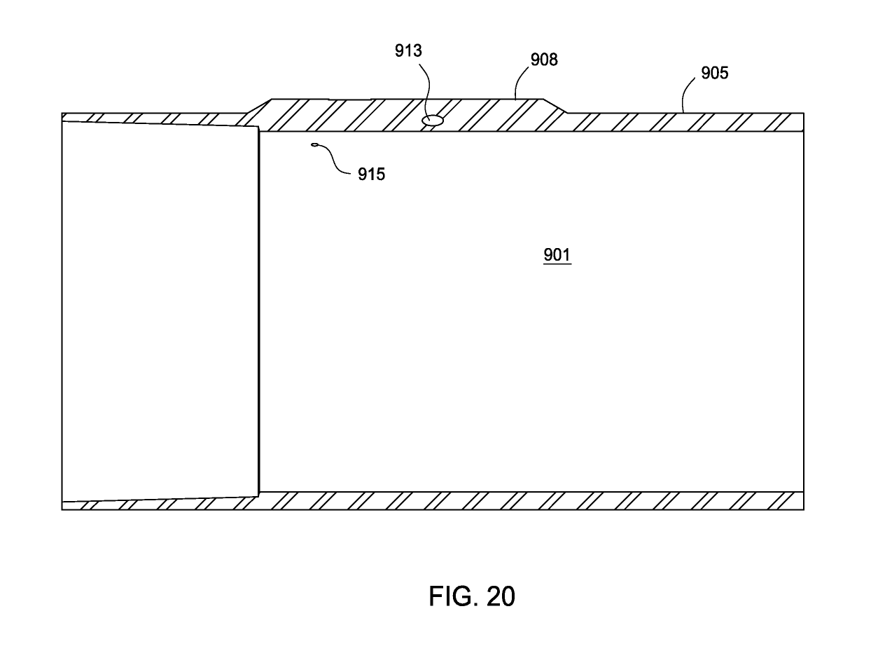

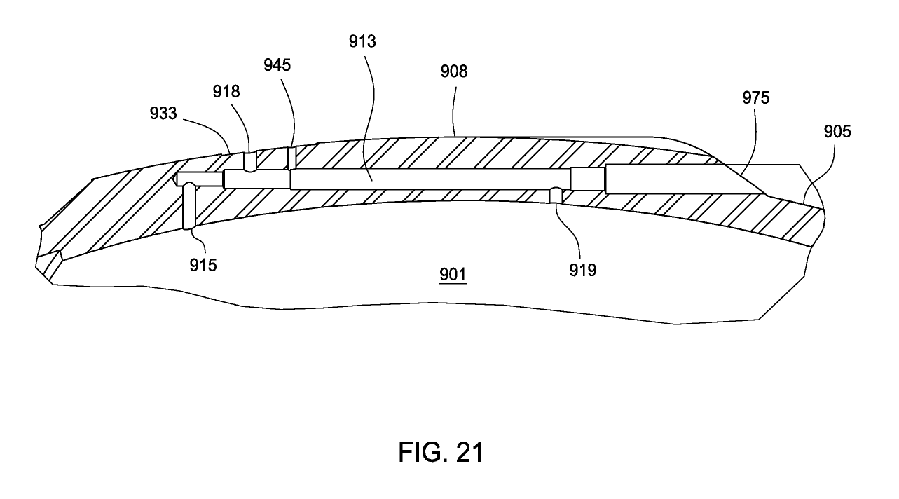

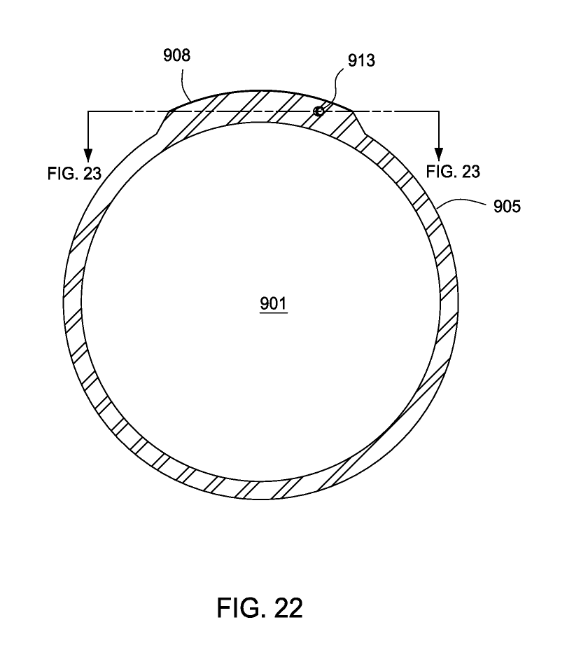

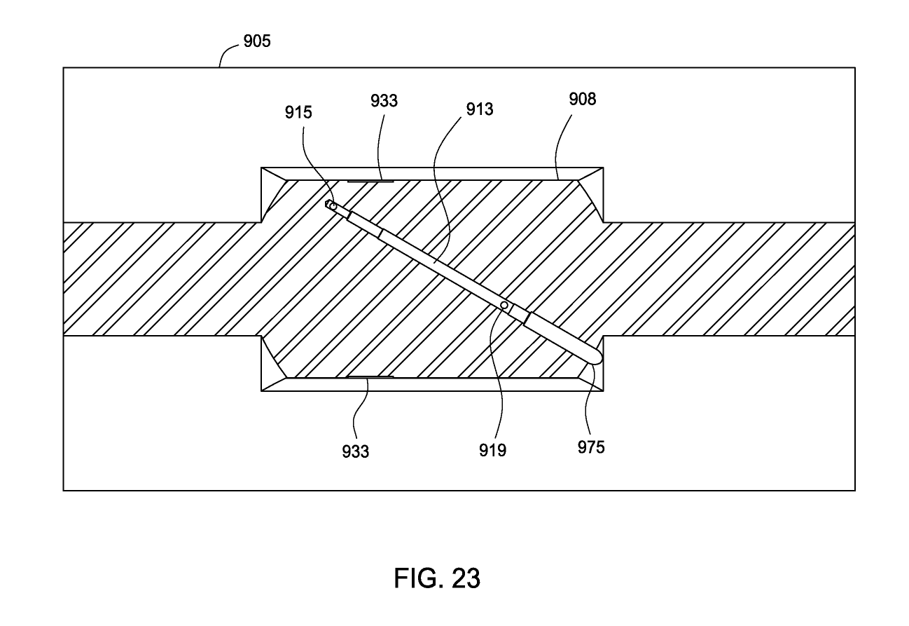

FIGS. 19-23 illustrate another embodiment of a tubular body 905 for a valve assembly. The tubular body 905 may receive the same valve components of the valve assembly 800 shown in FIG. 14 or the valve assembly 700 shown in FIG. 12. The tubular body 905 will be described using the components of the valve assembly 800 of FIG. 14. However, the details of the components of the valve assemblies will not be discussed in detail. FIG. 19 is a perspective view of one end of the tubular body 905. FIG. 20 is a cross-sectional view of the tubular body 905 taken at line A-A. FIG. 21 is a cross-sectional view of the tubular body 905 taken at line B-B. FIG. 22 is a cross-sectional view of the tubular body 905 taken at line D-D. FIG. 23 is a cross-sectional view of the tubular body 905 taken at line C-C.

The tubular body 905 has an axial bore 901 formed therethrough and may include threads at its ends for connection to a tubular such as casing 20. In another embodiment, the tubular body 905 may be integral with the casing 20. The body profile of the tubular body 905 may generally be concentric. In another embodiment, the tubular body 905 may be eccentric.

In one embodiment, a pad 908 is provided on the outer surface of the tubular body 905. As shown in FIGS. 20 and 22, the pad 908 increases the wall thickness of the tubular body 905 to a sufficient size to house the moving components of the valve assembly. The pad 908 may be a raised portion on the tubular body 905. The pad 908 may be any suitable shape for housing the valve components. As shown, the pad 908 is rectangular shaped. However, the pad 908 may have a circular or an oval shape. The pad 908 may also be arranged in any suitable orientation relative to the tubular body 905. For example, as shown, the rectangular shaped pad 908 is positioned in parallel with the tubular body 905. In another example, the rectangular shaped pad 908 may be angled relative to an axis of the tubular body 905. In yet another example, the pad 908 may be parallel with the angle of the chamber 913. In one embodiment, other than the pad section, the tubular body 905 may have a concentric wall thickness along its length. In this respect, the external pad 908 may provide increased flow path around tubular body 905.

The chamber 913 for housing the valve components is substantially formed through the pad 908 of the tubular body 905. An opening 975 is provided for access to the chamber 913 and installed of the valve components. In one embodiment, the chamber 913 is formed at an angle relative to the longitudinal axis of the tubular body 905, as shown in FIGS. 19 and 23. The angled chamber 913 allows the chamber 913 to be placed in the tubular wall closer to the inner diameter of the tubular body 905. As a result, the external pad 908 diameter can be reduced. In one embodiment, the chamber 913 is positioned at an acute angle relative to the longitudinal axis. In another embodiment, the chamber 913 is angled at about 5 degrees to 75 degrees relative to the longitudinal axis; preferably, at about 10 degrees to 60 degrees relative to the longitudinal axis. It is contemplated that the chamber 913 may be formed at any suitable angle to accommodate the size of the bore. In another embodiment, the chamber 913 may be angled relative to at least two planes, for example, a vertical plane and a horizontal plane.

In one embodiment, the chamber 913 is formed by drilling through at least a portion of the pad 908. In this respect, the chamber 913 is in the form of a bore, wherein an axis of the bore is angled relative to the longitudinal axis of the tubular body 905. In another embodiment, the bore may be angled relative to at least two planes.

In another embodiment, the chamber 913 may be positioned substantially parallel with the longitudinal axis. For example, in a casing having a larger annular clearance, the chamber 913 may be formed through the pad at an angle from about 0 degrees to 45 degrees relative to the longitudinal axis.

Similar to the chamber 913 of FIG. 14, this embodiment of the chamber 913 can fluidly communicate with a relief port 915 and a chamber port 919 of the body 905. The relief port 915 allows fluid communication between the bore 901 and the portion of the chamber 913 in front of the first seal on the closure member 820. The chamber port 919 allows fluid communication between the bore 901 and the portion of the chamber 913 defined by the second seal on the closure member 820 and the plug 828. An inflow port 918 and an actuation port 945 allow fluid communication between the exterior of the tubular body 905 and the portion of the chamber 913 between the first seal and the second seal of the closure member. These ports 918, 945 are blocked from fluid communication with the bore 901 by the closure member 820 when the valve assembly 900 is in the closed position. The inflow port 918 and the actuation port 945 are positioned such that in the open position, the inflow port 918 is allowed to communicate with the relief port 915, and the actuation port 945 remains blocked from communication with the bore 901. The operation of the valve assembly using this embodiment of the tubular body 905 is similar to the valve assembly 800 of FIG. 14 and will not be further described.

Referring to FIG. 19, a flow path 933 is provided on the outer surface of the pad 908 for fluid communication with the inflow port 918 and the actuation port 945. In one embodiment, the flow path 933 is a recess formed on the outer surface of the pad 908. As shown, the flow path 933 extends across two sides of the pad 908. The flow path 933 is also illustrated in FIGS. 21 and 23. The flow path 933 intersects with the inflow port 918 and the actuation port 945. In this respect, the flow path 933 ensures the ports 918, 945 can communicate with the exterior of the tubular body 905 even when the surface of the tubular body 905 containing the ports 918, 945 is laying or pushed up against another surface. For example, during operation, the side where the ports 918, 945 are located may rest against the wellbore wall. The flow path 933 ensures the ports are not blocked from fluid communication with the exterior of the tubular body 905.

It is contemplated the fluid path 933 may have any suitable arrangement. For example, the flow path 933 may be one or more channels formed in the pad 908 that intersect with one or both of the ports 918, 945. Also, the fluid path 933 may be a counter-sink recess formed around the one or both of the ports 918, 945. In yet another example, the ports 918, 945 may have separate fluid paths 933.

In any of the embodiments described herein, any of the casings 10, 20, 30 and/or the tubular members 40, 45 may each be provided with one or more valve assemblies 100, 200, 300, 400, 500, 600, 700, 800 to allow fluid flow from a surrounding casing or tubular member to an inner casing or tubular member, while preventing fluid flow in the opposite direction. In one embodiment, a casing or tubular member may be provided with multiple valve assemblies that are spaced apart along the length of the casing or tubular member. The valve assemblies 100, 200, 300, 400, 500, 600, 700, 800 may be operable to open and/or close at different pre-determined pressure setting.

Embodiments of the valve assemblies 100, 200, 300, 400, 500, 600, 700, 800 may be used to prevent collapse of a casing. For example, during an uncontrolled flow situation such as a catastrophic blowout, the hot hydrocarbon fluids from lower portions of the well may heat the fluid which is trapped in the annular space between an outer casing and an inner casing. The annular space may extend from top of the cement level to liner hanger. If the inner casing extends to the surface, then the annul area may extend from the top of the cement level and up to the surface. When the trapped fluid in the annular space is heated by the hot hydrocarbon fluids, the trapped fluid will expand. In some instances, this expansion can collapse the inner casing, thereby making future mitigation of the well more problematic. In this situation, presence of the valve assemblies 100, 200, 300, 400, 500, 600, 700, 800 allow the inner casing to bleed the pressure caused by the heat expansion. As a result, easier methods such as a capping stack can be used to get the well under control again.

In one embodiment, a valve assembly includes a tubular body having a port for fluid communication; a collar disposed around the tubular body; and a closure member disposed inside the collar and configured to control fluid communication through the port in response to a pressure differential. In another embodiment, the collar is eccentrically disposed relative to the body. In yet another embodiment, the closure member may be a sleeve or a piston.

In one embodiment, a valve assembly includes a tubular body having a port for fluid communication; a collar disposed around the tubular body; and a closure member disposed inside the collar and configured to control fluid communication through the port in response to a pressure differential.

In one or more of the embodiments described herein, the collar is eccentrically disposed relative to the body.

In one or more of the embodiments described herein, the closure member comprises a sleeve.

In one or more of the embodiments described herein, a seal is disposed on the closure member.

In one or more of the embodiments described herein, the collar and the body are integrally formed. In one or more of the embodiments described herein, the collar is formed as an enlarged section of the body.

In another embodiment, a method of controlling fluid communication between an exterior of a wellbore tubular and an interior of the wellbore tubular includes installing a valve assembly on the wellbore tubular, wherein the valve assembly includes a collar for housing a closure member and the closure member is configured to operate a port in the valve assembly; and moving the closure member away from the port to open the port in response to a predetermined pressure differential. In one or more of the embodiments described herein, the valve assembly further includes a body and the collar is eccentrically disposed around the body.

In one embodiment, a valve assembly includes a tubular body having a port for fluid communication between an exterior of the valve assembly and an interior of the valve assembly; a chamber formed in a wall of the tubular body, the chamber in fluid communication with the port; and a closure member disposed in the chamber and configured to control fluid communication through the port in response to a pressure differential.

In one or more of the embodiments described herein, the closure member includes a first portion having a smaller diameter than a second portion.

In one or more of the embodiments described herein, the valve assembly includes a seal disposed on each of the first portion and the second portion of the closure member.

In one or more of the embodiments described herein, a cap seal is disposed around the seal, wherein the cap seal has an outer surface that has less friction than the seal.

In one or more of the embodiments described herein, a biasing member is provided to bias the closure member in a closed position. In one or more of the embodiments described herein, a plug disposed on an end opposite the closure member.

In one or more of the embodiments described herein, an activation force of the closure member is adjustable.

In one or more of the embodiments described herein, the activation force is adjusted by changing a location of the plug.

In one or more of the embodiments described herein, the closure member is disposed in an enlarged cross-section of the tubular body.

In one or more of the embodiments described herein, the tubular body has an eccentric outer shape.

In one or more of the embodiments described herein, the closure member comprises a piston.

In another embodiment, a valve assembly includes a tubular body having an exterior port for fluid communication with an exterior of the valve assembly; and an interior port for fluid communication with an interior of the valve assembly; a chamber formed in a wall of the tubular body, the chamber in selective fluid communication with the interior port; a closure member disposed in the chamber and configured to control fluid communication through the interior port in response to a pressure differential between the exterior and the interior of the valve assembly; and a biasing member for biasing the closure member in a closed position.

In one or more of the embodiments described herein, the pressure differential required to open the valve assembly is adjustable.

In one or more of the embodiments described herein, the closure member includes a first portion having a smaller diameter than a second portion. In one or more of the embodiments described herein, a first seal disposed on the first portion and a second seal disposed on the second portion. In one or more of the embodiments described herein, the exterior port is located between the first seal and the second seal. In one or more of the embodiments described herein, the interior port is located ahead of the first seal.

In one or more of the embodiments described herein, a cap seal is disposed around at least one of the first seal and the second seal. In one or more of the embodiments described herein, the cap seal is configured to prevent extrusion from the closure member.

In one or more of the embodiments described herein, a plug is disposed on an end opposite the closure member. In one or more of the embodiments described herein, a distance between the plug and the closure member in the closed position is adjustable.

In one or more of the embodiments described herein, the chamber is formed at an angle relative to a longitudinal axis of the tubular body. In one or more of the embodiments described herein, the angle is about 15 degrees to 75 degrees.

In one or more of the embodiments described herein, the chamber is substantially formed in a raised portion of the wall having an increased wall thickness.

In one or more of the embodiments described herein, a fluid path formed on the raised portion in communication with the exterior port.

In another embodiment, a method of operating a valve assembly includes coupling a valve assembly to a casing, the valve assembly having a tubular body having a port for fluid communication between an exterior of the valve assembly and an interior of the valve assembly; a chamber formed in a wall of the tubular body, the chamber in fluid communication with the port; and a closure member disposed in the chamber and configured to control fluid communication through the port. The method further comprising opening the valve assembly in response to a predetermined pressure differential between the exterior and the interior of the valve assembly.

In one or more embodiments described herein, the valve assembly is configured to open at a predetermined pressure differential, thereby to preventing burst or collapse of the casings and/or tubular members.

While the foregoing is directed to embodiments of the invention, other and further embodiments of the invention may be devised without departing from the basic scope thereof, and the scope thereof is determined by the claims that follow.

1. A valve assembly, comprising:
a tubular body having a port for fluid communication between an exterior of the valve assembly and an interior of the valve assembly;
a chamber formed in a wall of the tubular body, the chamber in fluid communication with the port; and
a closure member disposed in the chamber and configured to control fluid communication through the port in response to a pressure differential.

2. The valve assembly of claim 1, wherein the closure member includes a first portion having a smaller diameter than a second portion.

3. The valve assembly of claim 1, further comprising a seal disposed on each of the first portion and the second portion of the closure member.

4. The valve assembly of claim 3, further comprising a cap seal disposed around the seal, wherein the cap seal has an outer surface that has less friction than the seal.

5. The valve assembly of claim 1, further comprising a biasing member for biasing the closure member in a closed position.

6. The valve assembly of claim 5, further comprising a plug disposed on an end opposite the closure member.

7. The valve assembly of claim 1, wherein an activation force of the closure member is adjustable.

8. The valve assembly of claim 7, wherein the activation force is adjusted by changing a location of the plug.

9. The valve assembly of claim 1, wherein the closure member is disposed in an enlarged cross-section of the tubular body.

10. The valve assembly of claim 9, wherein the tubular body has an eccentric outer shape.

11. The valve assembly of claim 1, wherein the closure member comprises a piston.

12. A valve assembly, comprising:
a tubular body having:
an exterior port for fluid communication with an exterior of the valve assembly; and
an interior port for fluid communication with an interior of the valve assembly;
a chamber formed in a wall of the tubular body, the chamber in selective fluid communication with the interior port;
a closure member disposed in the chamber and configured to control fluid communication through the interior port in response to a pressure differential between the exterior and the interior of the valve assembly; and
a biasing member for biasing the closure member in a closed position.

13. The valve assembly of claim 12, wherein the pressure differential required to open the valve assembly is adjustable.

14. The valve assembly of claim 12, wherein the closure member includes a first portion having a smaller diameter than a second portion.

15. The valve assembly of claim 14, further comprising a first seal disposed on the first portion and a second seal disposed on the second portion.

16. The valve assembly of claim 15, further comprising a cap seal disposed around at least one of the first seal and the second seal.

17. The valve assembly of claim 16, wherein the cap seal is configured to prevent extrusion from the closure member.

18. The valve assembly of claim 12, wherein the chamber is formed at an angle relative to a longitudinal axis of the tubular body.

19. The valve assembly of claim 18, wherein the angle is about 15 degrees to 75 degrees.

20. The valve assembly of claim 12, wherein the chamber is substantially formed in a raised portion of the wall having an increased wall thickness.

21. The valve assembly of claim 20, further comprising a fluid path formed on the raised portion in communication with the exterior port.

22. A method of operating a valve assembly, comprising:
coupling a valve assembly to a casing, the valve assembly having:
a tubular body having a port for fluid communication between an exterior of the valve assembly and an interior of the valve assembly;
a chamber formed in a wall of the tubular body, the chamber in fluid communication with the port; and
a closure member disposed in the chamber and configured to control fluid communication through the port
opening the valve assembly in response to a predetermined pressure differential between the exterior and the interior of the valve assembly.

23. The method of claim 22, wherein the predetermined pressure differential is set below the collapse pressure of the casing.

24. A valve assembly, comprising:
a tubular body having a port for fluid communication;
a collar disposed around the tubular body; and
a closure member disposed inside the collar and configured to control fluid communication through the port in response to a pressure differential.

25. The valve assembly of claim 24, wherein the collar is eccentrically disposed relative to the body.

26. The valve assembly of claim 24, wherein the closure member comprises a sleeve.
